(19) United States
(12) Patent Application Publication
(10) Pub. No.: US 2004/0023558 A1
(43) Pub. Date: Feb. 5, 2004

(54) Mid-connect architecture with point-to-point connections for high speed data transfer

(76) Inventors: Michael L. Fowler, Saco, ME (US); Oscar Freitas, Cape Elizabeth, ME (US); John F. Whalen JR., Windham, ME (US)

Correspondence Address: Sidley Austin Brown & Wood LLP, Suite 5000, 555 California Street, San Francisco, CA, 94104-1715, US

(21) Appl. No.: 10/459,916

(22) Filed: Jun. 11, 2003

Related U.S. Application Data
(63) Continuation-in-part of application No. 10/165,747, filed on Jun. 7, 2002.
(60) Provisional application No. 60/296,624, filed on Jun. 7, 2001.

(51) Int. Cl. H01R 24/00

(52) U.S. Cl. 439/632

(57) ABSTRACT

Interconnected systems of function cards are presented. An interconnected system may include function cards with substantially identical sets of connectors. The interconnected system includes two groups of function cards, where the function cards within a group are parallel to each other but are perpendicular to the function cards of the other group. The function cards have sets of connectors, which form connector arrays. The connector array of one group of the function cards is reciprocal to the connector array of the other group of function cards. This reciprocity makes it possible to couple the two groups of function cards without a printed circuit board or back plane. The connectors can be male or female, and the male and female connectors of a function card can be arranged in various connector groups. The connectors can form checkerboard and other alternated and interchanged arrays.

### CROSS-REFERENCE TO RELATED APPLICATION

This application is a continuation-in-part of U.S. patent application Ser. No. 10/165,747, filed on Jun. 6, 2002, entitled “Mid-Connect Architecture with Point-to-point Connections for High Speed Data Transfer” by Michael L. Fowler, Oscar Freitas, and John F. Whalen, which claims priority from U.S. Provisional Application No. 60/296,624, filed on Jun. 7, 2001, entitled “Mid-Connect Architecture”, both applications are hereby incorporated by reference in their entirety.

### BACKGROUND

1. Field of the Invention

The present invention relates to the physical layout of the communication interface architecture for an interconnect system, and more particularly, to a mid-connect architecture with point-to-point connections for high-speed data transfer.

2. Description of Related Art

Standards have been established for the architecture of the hardware employed to enable the exchange of electrical signals among processing devices. The processing devices include integrated circuit systems built on and using printed circuit boards by an increasingly wide array of suppliers. The architecture standards ensure that the various devices will, in fact, be able to communicate with one another as well as with central processing units that control the operation of such peripheral devices. These peripherals include, but are not limited to, printer interfaces, video, audio, and graphics interfaces, memory, external communications interfaces, or any other sort of discrete device performing particular computer-related functions.

The circuit boards associated with the peripherals may be activated upon connection with a primary printed circuit board, such as a motherboard, that establishes the physical interconnection of the central processing unit, power, memory structures, and the peripherals through an interconnection structure. The interconnection structure is a primary communication interface coupling device having connections to one or more slots or sockets in parallel into which circuit boards may be inserted. The slots include physical connectors and input/output interfaces to establish reception and transmission of signals among all devices coupled to the motherboard. It is the architecture of the interconnection structure that establishes the interface architectures required for the peripheral boards so that communication can occur between all peripherals and the central processing unit in an organized manner.

The interconnection structure is a printed circuit board or card used to enable the exchange of data (in the form of electrical signals) among other boards or cards connected to it. The structure is typically identified as a backplane having the interconnection slots on one side thereof. The backplane establishes the physical signal exchange interconnection among connected cards. The interconnections are ordinarily established by way of metal wires known as traces. The traces are the physical connections over which electrical signals pass among the various cards associated with the data transmission system. The particular signaling technology running through the traces influences the rate of signal exchange and the number of traces interconnecting individual cards influences signal exchange bandwidth.

Simply stated, the circuit boards or cards that are connected to the interconnection structure either transmit signals or receive signals. A card that is in a transmitting mode is described as a source card while one that is in receiving mode is described as a sink card or destination card. Apart from that most common set of attributes of a card that performs functions involving interaction with other cards, including a central processing unit, there are cards that operate solely to enable signal exchange. They are referred to as intermediate or switch cards in that they only relay signals between source and sink or destination cards. On the other hand, a function card is designed to carry out specified applications. Finally, a line card is a function card that provides for signal exchange with the external world.

As might be expected, the backplanes of interconnection structures take on various forms to provide the particular functionality required. For example, an active backplane includes one or more active elements that provide some logic functionality. That is, they provide some filtering and routing of signals. An often-used backplane is the motherboard, utilized, for example, in personal computers. Motherboards perform several functions in addition to filtering and routing. The components of motherboards may include microprocessors. A passive backplane, on the other hand, provides no such functionality but instead simply provides a physical medium through which signals are routed to and from all connected cards. While it provides no such filtering or routing capability, a passive backplane is important for system reliability in that all signals are permitted to pass through to each connected card, absent some sort of physical problem with a trace or traces.

As is well known in the art, a channel is a physical or optical pathway between the transmitters/receivers of individual cards and/or the central processor, memory, etc., of a data transmission system as well as external interfaces. Each channel is independent and can therefore transfer signals concurrently with other channels. In the field of signal exchange among multiple cards, there are key terms related to the data exchange channels. First, a multi-channel structure is one that includes multiple independent channels providing access from one or more cards to one or more cards. A multi-point channel is a single channel shared by a plurality of transmitting cards. A multi-drop channel, on the other hand, is one that is coupled to a single transmitting or source card but multiple receiving or sink or destination cards. A point-to-point channel is one that has two and only two card connections.

The importance of the backplane architecture established by the channel arrangement to the field of signal exchange is evident. In particular, it is noteworthy that different systems have different signal exchange requirements, and those requirements are dependent upon backplane channel layout. For example, in an equal access system, each card must transmit and receive a similar amount of information. Such systems include, but are not limited to, Local Area Network (LAN) switches, Wide Area Network (WAN) switches, and Redundant Array of Independent Disks (RAID). In a centralized access system, a single master card dominates access to the backplane and controls exchanges on the backplane. Such systems include, but are not limited to, personal computers. In a multiple access system, a plurality of cards require varying degrees of access to the backplane for transmission and reception as a function of time or particular application running. Such systems include, but are not limited to servers such as Internet Service Providers (ISPs).

In any of the systems described above, it is an important goal to provide a signal exchange system that enables signal exchange with little or no disruption. Increasingly, an important feature of the backplane is to provide for the transfer of greater quantities of signals (bandwidth) at faster propagation rates (high speed). Unfortunately, physical layout limitations and impedance concerns associated with the physical interconnections and signal drivers of many cards restricts high bandwidth, high speed signal transfer. Multi-channel, point-to-point or signal switch fabric interface (SSFI) backplane architecture has been recognized as a reasonable means to maximize signal bandwidth and propagation rates with high reliability. It is suitable for use in centralized and equal access environments. The SSFI backplane involves point-to-point connections enabling an increase in the number of cards connected to the backplane and greater channel access with a minimum number of backplane connections. However, the focus of high-speed signal change has been on internal switching, including through the use of midplane structures rather than backplane structures. There remains a need to increase the speed of data transmission in communications among external systems.

Therefore, what is needed is an interconnection structure that provides for high bandwidth, high-speed data transfer with little to no impact on signal integrity. Further, what is needed is such an interconnection structure that can be implemented using interface components substantially compatible with new and legacy circuit board interfaces. Yet further, what is needed is a high bandwidth, high speed interconnection structure suitable for deployment in the type of physical space generally available for computing systems. What is also needed is such an interconnection structure that makes efficient use of physical connectors or traces to reduce the impedances associated therewith. An additional need is to increase transmission rates for external signal exchange.

### SUMMARY

The present invention relates to the physical layout of the communication interface architecture for an interconnect system. More particularly, the present invention relates to establishment of the connections among individual circuit boards or cards of a system. The cards may be used for internal signal exchange among boards of the system or for external signal exchange between other systems or system boards such as would be used in a computer or data transmission system, though this invention applies to the actual interconnect within the system. The present invention provides for improved signal exchange at high speed through unique card-interconnect architecture.

The present invention comprises an interconnection structure that provides for high bandwidth, high speed data transfer while minimizing impact on signal integrity. In one embodiment, the present invention can provide an interconnection structure that can be implemented using interface components substantially compatible with new and legacy circuit board interfaces. In this or another embodiment, the invention provides an interconnection structure that does not utilize a printed circuit board, such as a backplane or midplane, to connect the various cards. The invention also provides a high bandwidth, high-speed interconnection structure suitable for deployment in the type of physical space generally available for computing and data transmission systems. Furthermore, the invention provides an interconnection structure that makes efficient use of physical connectors and traces to reduce the impedances associated therewith.

In one embodiment, the invention comprises a mid-connect structure rather than a backplane or midplane structure. More specifically, the invention comprises a mid-connect structure having on one side thereof a first set of function cards in parallel with one another and having a plurality of mid-connect elements applied thereto, and having on the other side thereof a second set of function cards in parallel with one another and having a plurality of mid-connect elements applied thereto. The first set of function cards are electrically coupled to the second set of function cards by connecting the mid-connect elements of the first set to corresponding mid-connect elements of the second set. The first set of function cards are oriented at an angle other than parallel relative to the second set of function cards. This allows one or more of the function cards on one side to attach to one or more of the function cards on the other side. Typically, this would be a perpendicular arrangement of the first set relative to the second set.

In another embodiment of the invention, the first set of function cards can include a first switch card and the second set of function cards can include a second switch card. The switch cards can establish all of the electrical interconnections in this embodiment. The first set of function cards can be electrically interconnected to one another through the second switch card, the second set of function cards can be electrically interconnected to one another through the first switch card, and the first set of function cards can be electrically interconnected to the second set of function cards through a combination of both the first and second switch cards. The switch cards can then provide a point-to-point switch fabric such that each connected function card has an interface to all other function cards through the switch cards.

To enable the high bandwidth, high-speed signal exchange indicated using the mid-connect configuration described, it is preferable to provide as part of the invention suitable signal transfer circuitry. The signal transfer circuitry should provide signal propagation substantially independent of particular signal exchange protocols. Accordingly, in an embodiment, each switch card includes, and each line or function card preferably includes, transceiver drivers suitable for high frequency propagation. These drivers include, for example, Gunning Transceiver Logic Plus (GTLP), Low Voltage Differential Signal (LVDS), and Positive Emitter Coupled Logic (PECL) drivers. The switch drivers enable signal propagation among cards and to upstream interfaces, such as internal circuitry of a data transmission system including the mid-connect or for interfacing to external devices. For the purpose of this disclosure, line and function cards will be referred to as function cards.

The design of the switch cards is important in the scheme of the invention. The switch cards should be configured with the processing logic necessary to ensure proper transfer of signals among the various cards connected in the slots of the mid-connect. In one embodiment, the processing logic is configured to recognize all signal transmission protocols so, that cards with differing protocols may interface with one another. Therefore, the mid-connect of the invention can be independent of signal protocols and can be suitable as an exchange for legacy and future card protocols. The switch cards of the invention therefore employ, in an embodiment, SerDes and crosspoint switching configurations of the type well known in the art. Moreover, data packeting and arbitration logic are relatively simple to maximize reliable throughput.

Further, interconnected systems of function cards are described according to embodiments of the invention. An interconnected system may include function cards with substantially identical sets of connectors. The interconnected system includes two groups of function cards, where the function cards within a group are parallel to each other but are perpendicular to the function cards of the other group. The function cards have sets of connectors, which form connector arrays. The connector array of one group of the function cards is reciprocal to the connector array of the other group of function cards. This reciprocity makes it possible to couple the two groups of function cards without a printed circuit board or back plane.

The connectors can be male or female, and the male and female connectors of a function card can be arranged in various connector groups. The connectors can form checkerboard and other alternated and interchanged arrays.

These and other advantages of the invention will become apparent upon review of the following detailed description, the accompanying drawings, and the appended claims.

### BRIEF DESCRIPTION OF THE DRAWINGS

FIG. 1 is a perspective view of the mid-connect layout of the present invention showing an exemplar set of 21 switch cards interconnected to 21 function cards.

FIG. 2A is a detailed perspective view of the connecting of an exemplar switch card to an exemplar function card.

FIG. 2B is a detailed view of a pair of through connectors formed of a female connector and a male connector used to connect an exemplar switch card to an exemplar function card.

FIG. 2C is a detailed perspective view of the connecting of an exemplar switch card to an exemplar function card using an optical connection.

FIG. 2D is a detailed perspective view of the connecting of an exemplar switch card to an exemplar function card using an optical connection, wherein the optical connection comprises both an optical transmitter and an optical receiver that is employed at both the switch card and at the function card.

FIG. 3 is front view of an exemplar switch card coupled to a plurality of function cards.

FIG. 4 is front view of an exemplar function card coupled to a plurality of switch cards in a first switch arrangement.

FIG. 5 is a front view of an exemplar function card coupled to a plurality of switch cards in a demultiplexer connection arrangement.

FIG. 6 is a perspective view of a mid-connect layout of the present invention showing the mid-connect structure as a midplane structure.

FIG. 7 is a perspective view of a mid-connect layout of the present invention showing a multi-plane switching, mid-connect interconnection system.

FIGS. 8A to 8C are top views of different embodiments of the multi-plane switching, mid-connect interconnection system of FIG. 7.

FIG. 9 is a perspective view of a System Area Network in a Box (SANB) constructed using the mid-connect interconnection system of the present invention.

FIG. 10 illustrates aspects of the mid-connect layout.

FIGS. 11A-D illustrate a geometrical transformation on the second set of function cards.

FIGS. 12A-B illustrate various embodiments of male and female connector arrangements.

FIG. 13 illustrates male and female connector groups.

FIG. 14 illustrates male-female connector groups.

FIG. 15 illustrates a checkerboard pattern of male-female connector groups.

### DETAILED DESCRIPTION

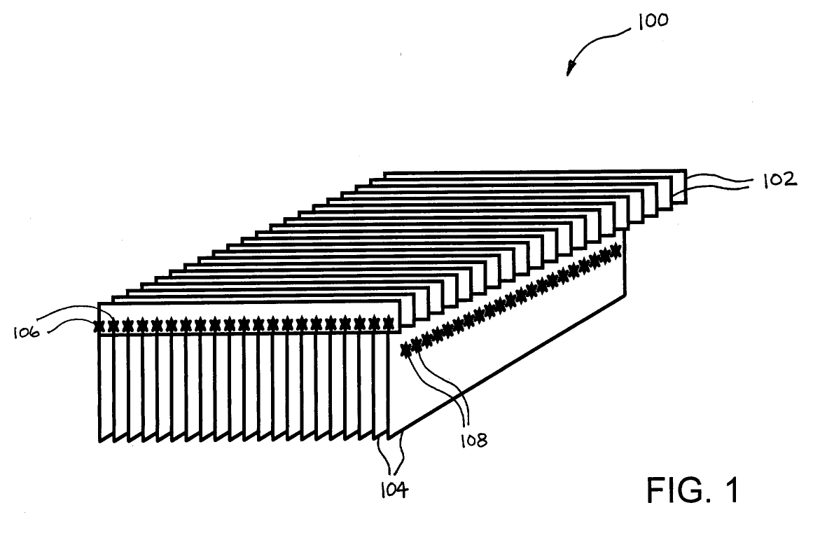

FIG. 1 shows a mid-connect interconnection system 100 according to one embodiment of the invention. This embodiment includes a plurality of switch cards 102 and a plurality of function cards 104 interconnected each directly to the other through a connector arrangement. Mid-connect interconnection system 100 is configured such that switch cards 102 are perpendicularly oriented relative to function cards 104. In such an orientation, each switch card 102 is in electrical contact with every function card 104, and therefore the switching circuitry of each switch card 102 can be directly connected to all of function cards 104. This arrangement effects a direct connection of each function card 104 to all other function cards 104 through switch cards 102. Switch cards 102 can include switch card side interfaces 106 to function cards 104. Likewise, function cards 104 can include function card side interfaces 108 to switch cards 102. Interfaces 106 and 108 can comprise switch devices or drivers/receiver pairs to complete signal propagation among function cards 104.

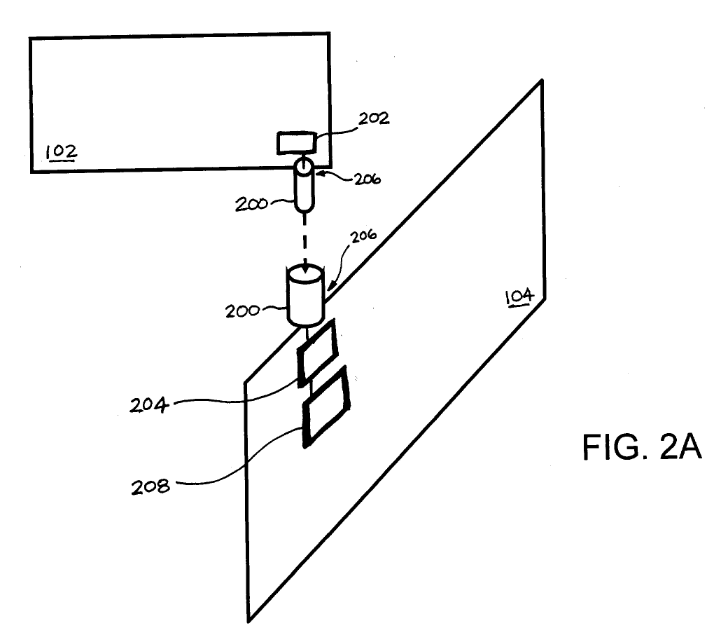

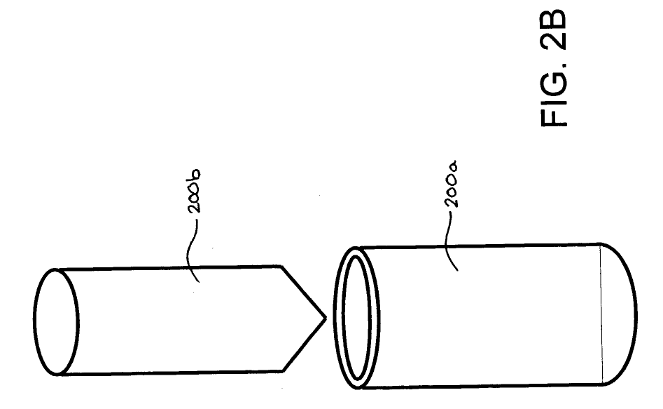

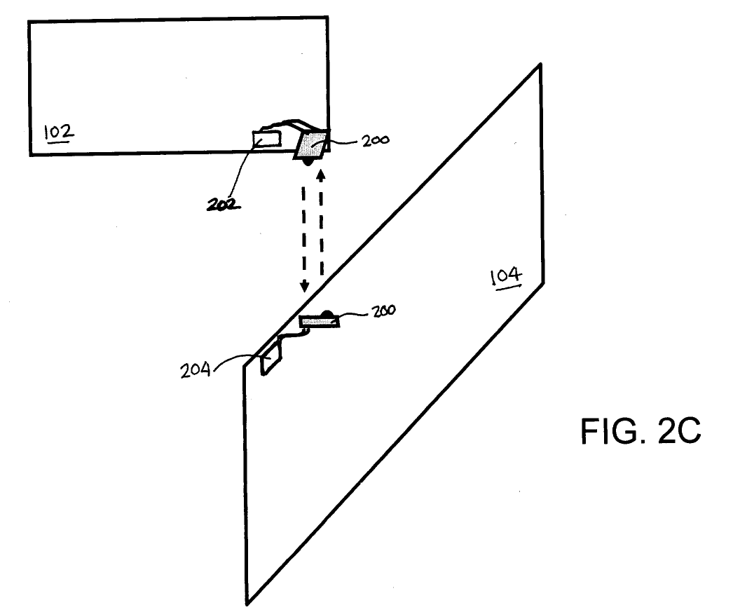

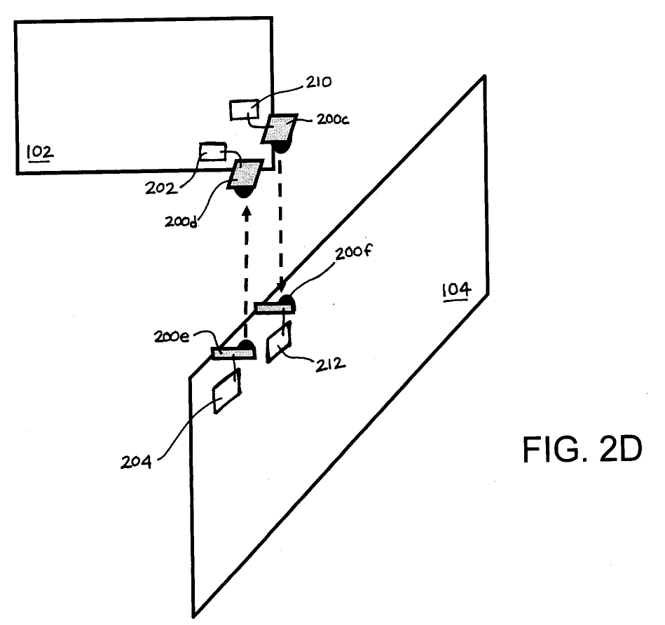

Turning to FIG. 2A, in an embodiment, mid-connect interconnection system 100 includes a plurality of through connectors 200 to establish the interconnection of switch cards 102 to function cards 104. Connector pairs 200 between switch cards 102 and function cards 104 provide for fast signal transmission with minimal reflections and without the need for a backplane or a midplane structure. Interface devices, such as drivers, receivers, or full duplex driver/receiver pairs 202 and 204, can be employed on each of cards 102 and 104 to establish a suitable electrical signal exchange.

Generally, each switch card 102 preferably has a discrete driver/receiver pair 202 for each connector, while each function card 104 includes a similar discrete driver/receiver pair 204. In some embodiments, driver/receiver pairs may be employed solely on switch cards 102 or solely on function cards 104. Driver/receiver pairs 202 and 204 are located proximate to connector 200, thereby minimizing stub length between connector 200 and driver/receiver pairs 202 and 204. This enables a high-speed data transfer between driver/receiver pairs 202 and 204. Further, each function card 104 can also include an on-card driver/receiver pair 208, generally embedded in an Application-Specific Integrated Circuit (ASIC) or Application-Specific Standard Product IC (ASSP) chip. In embodiments where cost is more important than the rate of data transfer, the invention can eliminate the use of driver/receiver pairs 202 and 204 and rely instead on the ASIC or ASSP driver/receiver pair 208.

In an exemplary arrangement having twenty-one switch cards and twenty-one function cards, a 21×21 array of through connectors 200 is required. As shown in FIG. 2A, to provide substantially maximum frequency performance, it is possible in an embodiment of this invention to place drivers/receiver pairs 202 and 204 directly at card edges 206 of connector 200 to minimize stub length on both sides of connector 200. Drivers/receiver pairs 202 and 204 are preferably coupled to each of connectors 200 for optimum frequency transmission. It should be noted that driver/receiver pairs 202 can take the form of a full duplex transceiver as well. Since there is generally only one connector 200 and no traces between driver/receiver pairs 202 and 204, there is a minimal distance for the signal to traverse, thus reducing impedance and variances in impedance in the distance that the signal must travel, and thereby maximizing the frequency performance of the signal. To further enhance the high performance capability on the card, it is possible to either multiplex the signal at driver/receiver pair 202, or demultiplex the signal at driver/receiver 204. It is also possible to produce a maximum frequency signal on the card since this is a point-to-point connection in a well controlled impedance environment of a printed circuit board with no connectors 200 between driver/receiver pair 202 on the card causing unwanted changes in impedance.

As shown in FIG. 2B, in one embodiment connectors 200 may be established as a set of pairs or sets of pairs of through connectors 200 formed of a female connector 200a and a male connector 200b. Female connector 200a includes a socket into which male connector 200b fits. Those skilled in the art will readily recognize that such connectors can be deployed in the cards. Further, those skilled in the art will recognize that alternative means can be employed to establish short-length connections between switch cards 102 and function cards 104. Moreover, the invention can be arranged so that female connectors 200a are established on switch cards 102 and male connectors 200b are established on function cards 104, or vice-versa.

As shown in FIG. 2C, in an alternative embodiment, connectors 200 can be established as an optical connection between switch card 102 and function card 104. As in other embodiments, driver/receiver pairs 202 and 204 can be located proximate to each connector 200 for optimum frequency transmission. When an optical connection is used, a backplane is not required. For multi-point, duplex mode connections, connector 200 will comprise two pairs of optical connectors. As shown in FIG. 2D, an optical transmitter 200c and an optical receiver 200d can be employed at switch card 102, while a corresponding optical transmitter 200e and optical receiver 200f can be employed at function card 104 as well. Driver/receiver pairs 202 and 204, as well as additional driver/receiver pairs 210 and 212, can be located proximate to each connector 200 for optimum frequency transmission.

The arrangement of sets of pairs of through connectors 200 is determined by a user as a function of throughput required, transceiver technology employed, and layout space available. In embodiments of the invention, card cages can be used to hold switch cards 102 and function cards 104 stable, and a support structure can also be deployed between cards. In the arrangement of mid-connect interconnection system 100 shown in FIG. 1, the communication established is multi-channel, point-to-point with full duplex connections. However, in alternative embodiments, any sort of communication form may be employed with system 100 of the invention including, but not limited to, unidirectional and bi-directional communications. Of course, two trace sets of through connectors 200 are generally required for bi-directional communication. Full duplex communication enables sourcing and sinking from or to each function card 104 via switch cards 102, and it doubles the performance parameters compared to unidirectional transmission. Alternatively, unidirectional operation halves the number of required trace sets as that of the bi-directional embodiment.

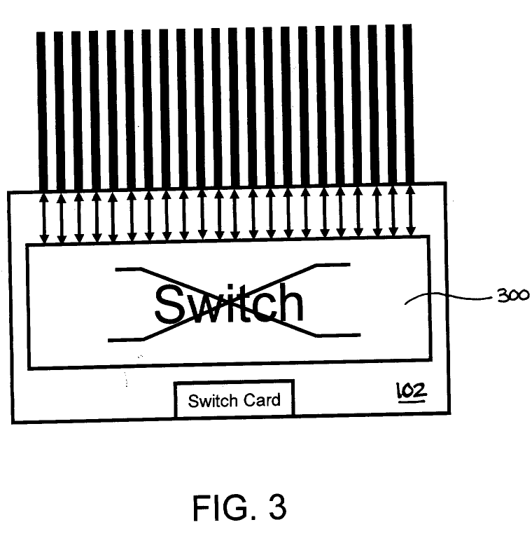

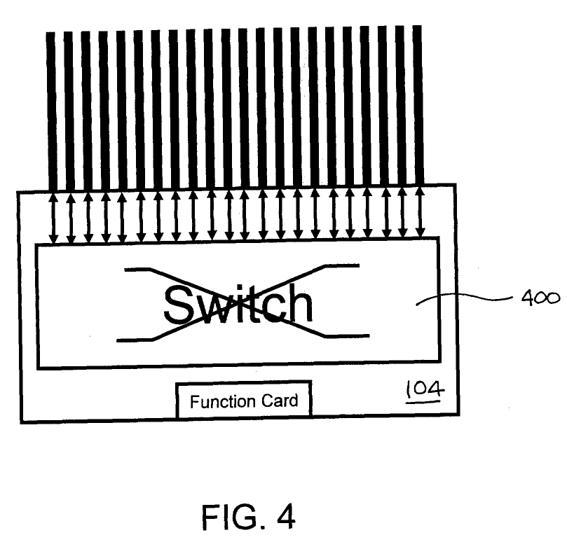

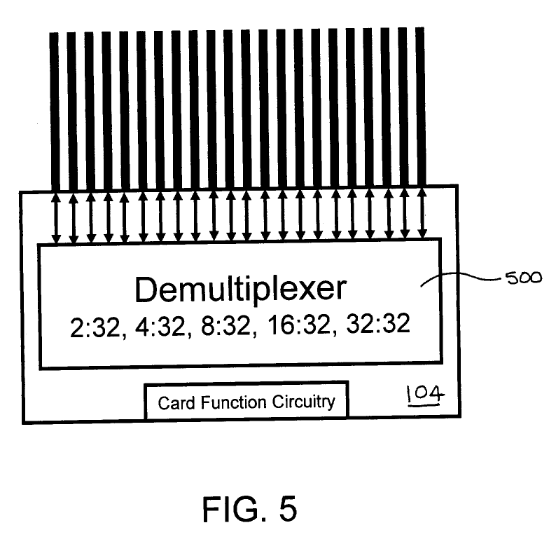

As illustrated in the embodiments of FIGS. 3 and 4, each switch card 102 can include a switch device 300, and each function card 104 can include a switch device 400. In another embodiment, as shown in FIG. 5, a demultiplexer 500 can be employed on one or more of function cards 104 to reduce the number of direct connections associated with switch cards 102. Each of the respective switch devices 300 and 400 may be selected by the user, but switch devices that are particularly well suited for use in the invention include, for example, the LVDS family of switches offered by Fairchild Semiconductor Corporation of South Portland, Me. Alternatively, a Positive Emitter Coupled Logic (PECL) switch may be employed, particularly to maximize throughput. In the arrangement shown in FIG. 4, each function card 104 has the full bandwidth of X Gbps by Y switch connections available. In other embodiments, resources can be located on switch cards 102, if desired. Moreover, effective redundancy can be accomplished by deselecting a switch card 102 upon the failure of that single switch card 102. For the arrangement shown in FIG. 5, each function card 104 has the full bandwidth of X Gbps by Y switch connections available, while the demultiplexer allows for a lesser number of switch cards 102 to be connected, thus improving scaling performance.

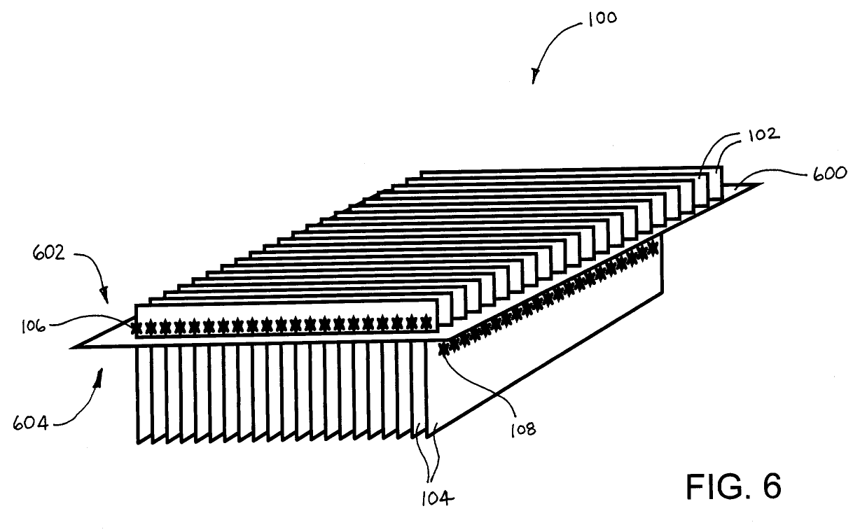

In an alternative embodiment of the invention shown in FIG. 6, mid-connect interconnection system 100 of the invention comprises a printed circuit board such as a midplane structure 600 that functions as a card cage to support and align switch cards 102 on a first mid-connect side 602, and to support and align function cards 104 on a second mid-connect side 604, in a connection manner well known to those skilled in the art. Connectors 200, with accurate alignment provided by midplane structure 600 as they are attached to switch cards 102 and function cards 104, may each be unitary and pass completely through the body of the structure 600, or they may be discrete elements on each of sides 602 and 604 but electrically coupled together.

With continuing reference to FIG. 6, midplane structure 600 is configured with a plurality of slots on each of sides 602 and 604 for receiving therein a selectable number of switch cards 102 and a selectable number of function cards 104, respectively. The slots of structure 600 are arranged so that switch cards 102 are perpendicularly oriented relative to function cards 104. As explained above, in such an orientation, the switching circuitry of respective switch cards 102 can be directly connected to all of function cards 104 to effect a direct connection of each function card 104 to all other function cards 104 through switch cards 102. Switch cards 102 can include switch devices 300 and function cards 104 can include switch devices 400 to complete signal propagation interfaces among function cards 104. Alternatively, switch cards 102 and function cards 104 can include drivers/receiver pairs 202 and 204 (as shown in FIG. 2) for signal propagation.

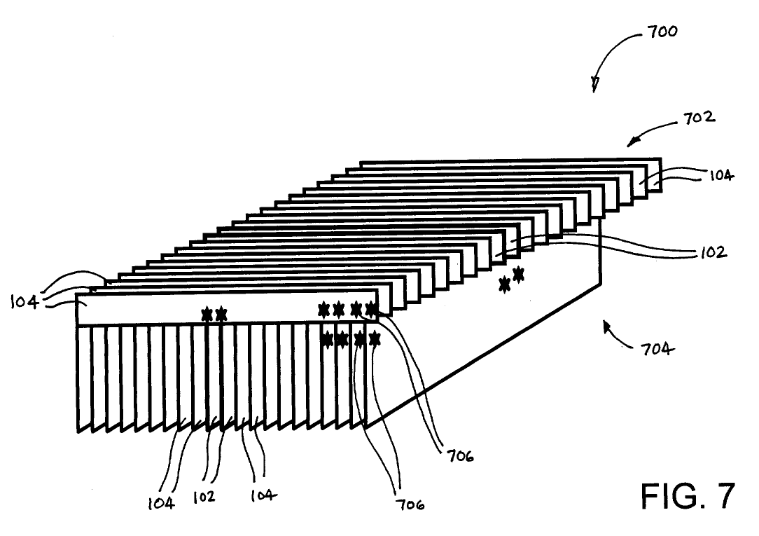

In another embodiment of the invention, it may be desirable to provide direct connections between two function cards 104 or sets of function cards 104, rather than providing point-to-point connections through switch cards 102. Accordingly, FIG. 7 shows an embodiment of the invention that comprises a multi-plane switching, mid-connect interconnection system 700, which includes switch cards 102 and function cards 104 in both a first plane 702 and a second plane 704 of the invention. In the embodiment of FIG. 7, there are two switch cards 102 in each plane 702 and 704 of mid-connect interconnection system 700. The remaining cards are function cards 104. It should be noted that the number of switch cards 102 is not restricted to any particular number, and each plane can have anywhere from 0% to 100% of its slots filled with switch cards 102. The remaining slots are accordingly filled with function cards 104. In FIG. 7, two switch cards 102 are provided in each plane 702 and 704 for purposes of redundancy.

Having function cards 104 in both planes 702 and 704 of mid-connect interconnection system 700 allows all of function cards 104 in plane 702 to be directly coupled to all of function cards 104 in plane 704. The direct connections can be through switches or multiplexer/demultiplexer pairs located on function cards 104 themselves, or through direct point-to-point connections to and from a function or resource block on two or more cards. The connections can also be between multiple functions on a single card or multiple channels to an individual function. In the embodiment of FIG. 7, there can be an electrical connection between function cards 104 at every intersection of function cards 104, or there can be connections only between select function cards 104, dependent upon where connections between function cards 104 are required.

In the embodiment of FIG. 7, system sections can be partially isolated from one another within a card cage. This can be beneficial in optimizing performance of the system when there are multiple, independent functional blocks in the system. One example of such a system with multiple functional blocks is a single overall system providing all of the functionality required for an Infiniband Subnet, or an Internet or Application Service Provider physical site comprised of routers, switches, storage, and servers. All of these functions can fit well into mid-connect interconnection system 700 using the direct connections between function cards 104. Isolation of functional blocks within a system can also prove useful for security purposes.

As with previous embodiments, interfaces 706 can be provided on function cards 104 to complete signal propagation among function cards 104. Interfaces 706 can comprise switch devices or drivers/receiver pairs, and can directly couple function cards 104 in plane 702 to function cards 104 in plane 704.

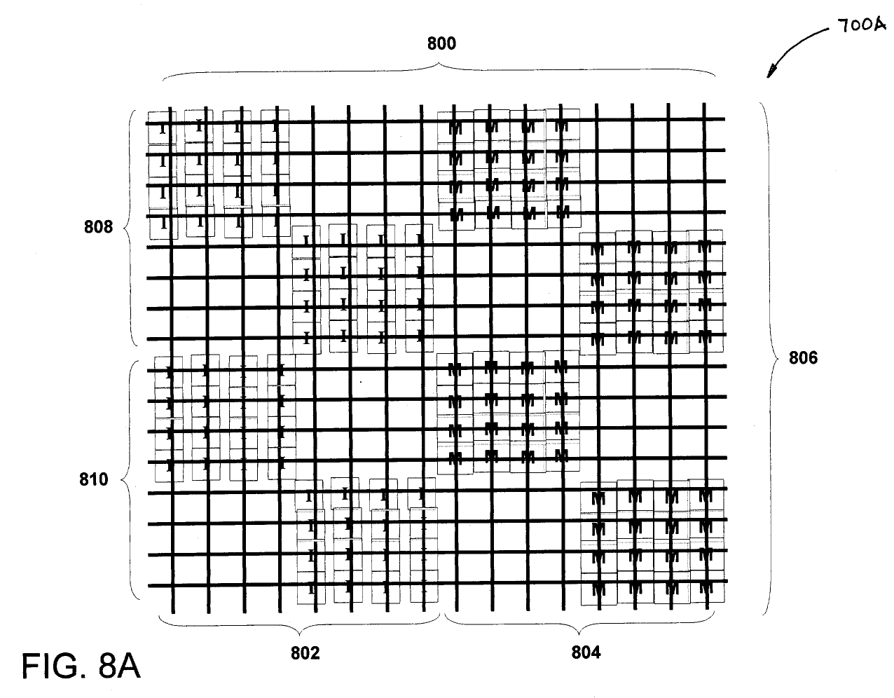

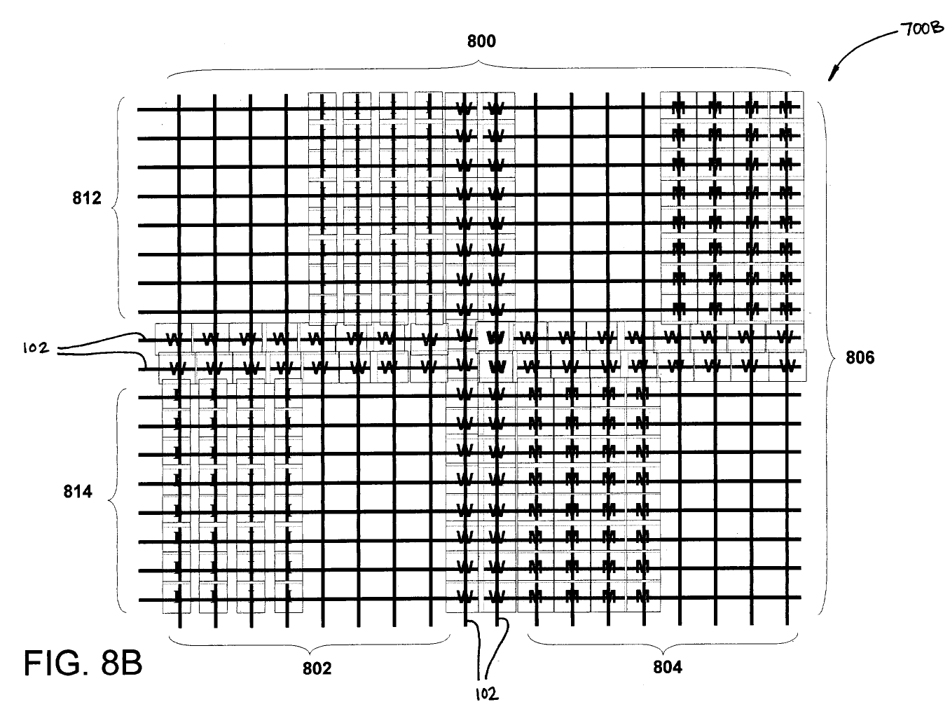

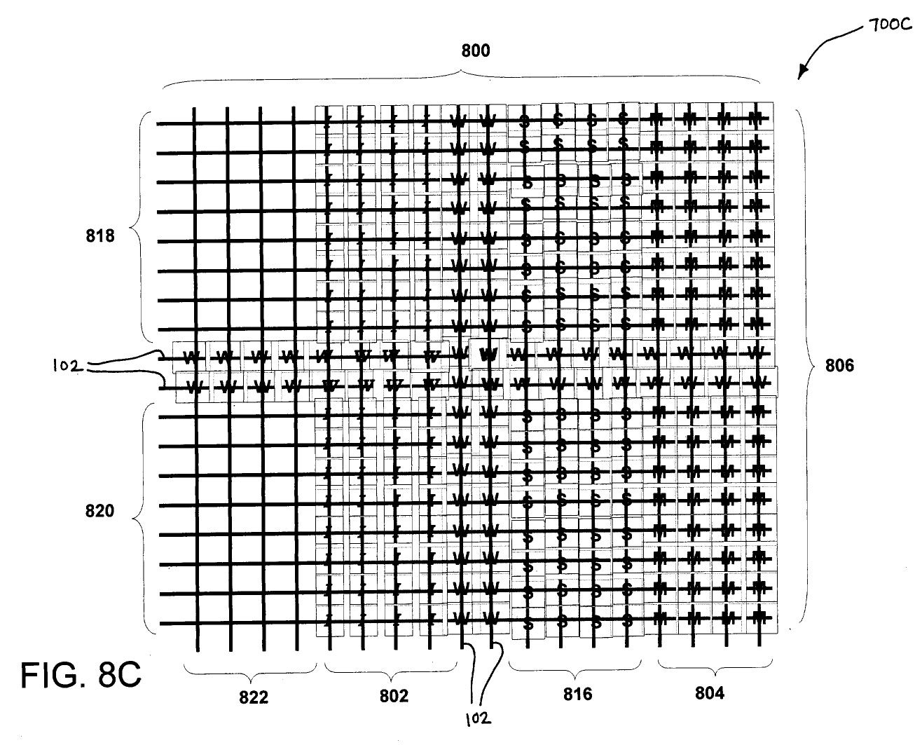

FIGS. 8A to 8C are top-views of different embodiments of mid-connect interconnection system 700. Each line in FIGS. 8A to 8C represents a function card 104. FIG. 8A illustrates an embodiment of mid-connect system 700, herein labeled 700A, with primary storage and processing function cards 104 using only direct, card-to-card connections, and no switch cards 102. In this embodiment, function cards 104 in a first plane 800 comprise input/output cards 802 and memory cards 804. Memory cards 804 generally contain memory commonly found in computer systems, including but not limited to DRAM memory. In a second plane 806 of system 700A, function cards 104 comprise two sets of cards 808 and 810 that can perform different tasks. In FIG. 8A, system 700A comprises a 16×16 array of function cards 104, although in alternate embodiments any number of function cards 104 can make up the array. In FIG. 8A, the label “I” on the connections between input/output cards 802 and cards 808 and 810 indicates a connection where input/output data is passed. And the label “M” between memory cards 804 and cards 808 and 810 indicates a connection where memory data is passed.

FIG. 8B illustrates an embodiment of system 700, herein labeled 700B, with primary storage and processing function cards 104 with independent support cards (input/output and memory) for each. As in FIG. 8A, first plane 800 comprises input/output cards 802 and memory cards 804. Second plane 806 comprises a set of storage cards 812 and a set of processor cards 814. Half of input/output cards 802 are used by storage cards 812, and half are used by processor cards 814. Likewise, half of memory cards 804 are used by storage cards 812, and half are used by processor cards 814. Furthermore, system 700B includes two pairs of switch cards 102, one pair disposed in plane 800, and the second pair disposed in plane 806. As before, the label “I” indicates a connection where input/output data is passed, and the label “M” indicates a connection where memory data is passed. In addition to there, in FIG. 8B the label “W” indicates a switch connection.

In FIG. 8C, an embodiment of system 700, labeled system 700C, is shown containing function cards 104 comprising primary processing cards with common support cards and storage cards. Function cards 104 of plane 800 include input/output cards 802, memory cards 104, a pair of switch cards 102, and storage cards 816. Memory cards 104 generally contain volatile memory, such as DRAM, while storage cards 816 generally contain non-volatile memory, such as a hard disk drive. Function cards 104 of plane 806 include two sets of processor cards 818 and 820. Furthermore, plane 800 can include wild cards 822 that can be used for any desired functionality. In FIG. 8C, in addition to the previously mentioned labels, the label “S” indicates a connection over which storage data is passed.

It should be noted that the embodiments shown in FIGS. 8A to 8C are merely three examples of the limitless number of embodiments possible for mid-connect interconnection system 700. All types of function cards 104 that are available can be used in this invention, and in any number. Likewise, more or less than two switch cards 102 can be used in any embodiment as well.

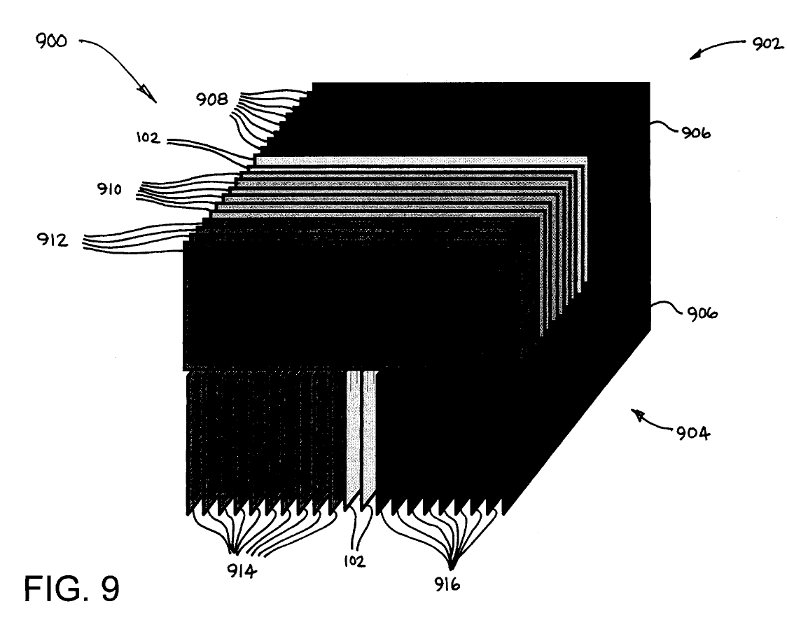

Turning to FIG. 9, another embodiment of the invention is shown that comprises a System Area Network in a box (SANB) 900. In SANB 900, it is possible to put all of the components from a System Area Network into a single structure while allowing for modular scalability of any component as required by the system expansion needs. In one embodiment of SANB 900, the preferred method can be to use switch connections only, though direct connections can be used for higher performance on specific connections between specific function cards 104. As many connections are possible at the intersection of function cards 104 from the two planes of SANB 900 as can be fit into the spacing between these function cards 104. At the intersection of switch cards 102, the invention can provide many connections to adequately address the bandwidth needs caused by many function cards 104 attempting to access through switch cards 102 in both planes.

All of the conventional components of a System Area Network, such as routers, switches, servers, storage, RAIDs, I/O, and memory, can be placed into the architecture of SANB 900 as card components. If SANB 900 is a switch-connect system only, then any of the card components can be placed at any card location except slots that are dedicated to switch cards 102, since the switch component connector configuration is different. If all intersections between function cards 104 have connectors, then any function card 104 can be placed in any slot of SANB 900.

In FIG. 9, SANB 900 comprises two planes 902 and 904. In plane 902, SANB 900 includes function cards 104 consisting of at least one router card 906, memory cards 908, storage cards 910, and input/output cards 912. There are also two switch cards 102 in plane 902. In plane 904, function cards 104 include director cards 914, and server cards 916. Plane 904 also includes a pair of switch cards 102, and at least one router card 906.

The mid-connect interconnection system of the present invention allows for easy upgrading to the next level of performance, since there is no fixed backplane or midplane between function cards 104. In the case of multi-plane switching, all that is required is that switch cards 102 be changed with backward compatible upgraded switch cards 102. Then all other cards, namely function cards 104, can be upgraded as well.

This ability to upgrade the card interconnections is due to the fact that there is no printed circuit card to limit the connections. Every connector and card is an isolated, replaceable piece of the system. When configured correctly, the ability to add connections, provide higher speed connections, or change transmission media (i.e. electrical to optical) is possible. It is preferred to leave the original connector as part of the new connection scheme to allow for backward compatibility to the original components of the system. It is also preferred to leave expansion room available between connectors to be able to widen the connector with more connections.

The distribution of power within mid-connect interconnection systems 100 and 700, or within SANB 900, presents a unique challenge to the virtual backplane architecture of the invention. In the absence of an actual printed circuit board for card interconnect, a new way to distribute power between cards is required. In the case of a multi-plane switching system, with dedicated switch cards 102 in each plane of the system, the task can be relatively straightforward. In one embodiment, power distribution can reside on switch cards 102 with power connections provided for each of function cards 104 in the opposing plane. Since switch cards 102 are generally present in a switch based system, power would always be present. In the embodiment used for redundancy, which requires at least two switch cards in each plane, power redundancy would also be provided.

Another approach if switch card 102 cannot be used to supply power, or in the instance of a non-switch card based system, would be to dedicate slots to the power distribution task. Again, two power distribution slots or cards in each plane with connections from each power card to each function card 104 in the opposing plane would allow for redundancy.

Mid-connect systems 100 and 700, as well as SANB 900, of the present invention establish a signal switching fabric interface that enables high bandwidth, high-speed throughput. Use of the present invention eliminates the need for a backplane or midplane card, thereby allowing any failures to be single point failures, and providing for limitless upgradeability. The invention creates a very dense system structure, approaches subnet level complexity, maximizes link speeds, and provides for simple optical connections. The invention also provides multi-stage connects, including direct card-to-card interconnects, multiplexed connects, single-stage switching, and multi-stage switching.

In some embodiments of mid-connect systems 100 and 700 switch cards 102 in each plane connect to all of function cards 104 in the opposite plane as well as switch cards 102 in the opposite plane. Function cards 104 of each plane only need to connect to switch cards 102 in the opposite plane. For this reason switch cards 102 have long lines of connectors for function cards 104 in the opposite plane, whereas function cards 104 have two sets of connections—one set for each switch card 102. Function cards 104 may have connections to other function cards in the opposite plane, but it is not necessary. Finally, switch card to switch card connections may have higher bandwidth than function card to switch card connections, resulting in more connections and/or higher data rate.

The invention has a wide array of applications including, but not limited to, multi-processor servers, LAN and WAN routers and switches, and RAIDs. Further, the switch cards can be configured to manage any sort of signal propagation protocol including, but not limited to, Ethernet, Fibrechannel, Infiniband, and RapidIO, for example, each having its particular switch architecture. The point-to-point arrangement described permits the simplest form of data transmission to fit into the space available, especially if high-speed transceivers are employed such as is available through GTLP, LVDS, and PECL. This enables a system providing minimum distance between connections for a virtually unlimited number of switch cards 102 and function cards 104, with a virtually unlimited number of channels.

It is contemplated that the present invention provides a convenient layout capable of handling channel speeds of the type associated with Ethernet, Infiniband, and Synchronous Optical Network (SONET/SDH), for example, and with substantially more cards than has heretofore been possible. In particular, 2.5 Gigabits per second (Gbps) transmission may be generated using the transceiver drivers identified. In the exemplar mid-connect arrangement shown in a full duplex mode, with 21 switch cards and 21 line cards, it is possible to provide a bandwidth on the order of 21×21×2×2.5 Gbps=2.205 Terabits per second. That sort of bandwidth is enabled in the invention using an efficient connection layout in a board space of the type currently available and with transceiver drivers currently available.

Similar performance can be shown for a computer system, rather than a data transmission system, without the need for the switches on the function cards. In this case, to provide scalable performance, a variable number of input de-serializers would be required on the function cards. In this way, the number of switches could be adjusted to the scaled performance requirements.

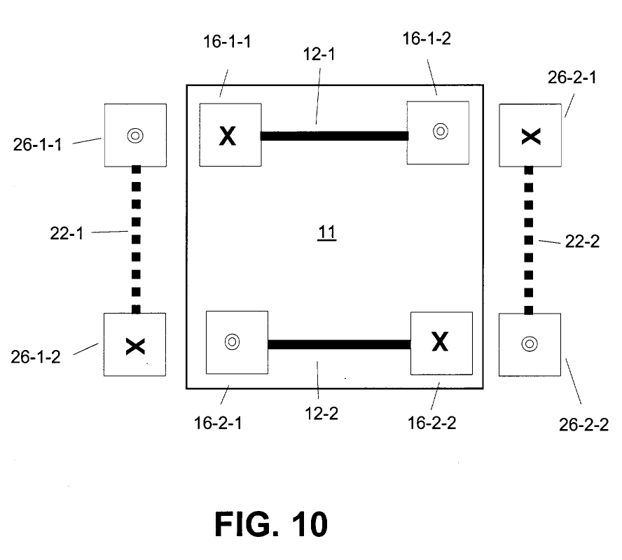

FIGS. 10-16 illustrate other aspects of interconnected system 100, according to embodiments of the invention. Some embodiments have both male and female connectors along the edges of function cards, similarly as it was shown in FIG. 2A. The connectors may be positioned directly on the edges or in a close vicinity of the edges. Returning to FIG. 10, function cards 102 (not shown) are oriented outward of the plane of the FIG. 10, having horizontal edges 12-1 and 12-2, and function cards 104 (not shown) are oriented behind the plane of FIG. 10, having vertical edges 22-1 and 22-2. The connection region between the set of function cards 102 and the set of function cards 104, defined by the edges of the function cards, will be referred to as virtual mid-plane 11.

An individual function card has a set of connectors. These connectors can include male and female connectors. The connectors of function cards 102 form a first connector array, the connectors of function cards 104 form a second connector array.

In embodiments, where the male connectors of the second connector array are aligned with the female connectors of the first connector array, and the female connectors of the of the second array are lined up with the male connectors of the first array, the first connector array will be referred to as reciprocal to the second connector array. While denoted by different numbers, function cards 102 and 104 can have the same set of connectors. In some embodiments, function cards 102 and 104 are in fact substantially identical function cards.

Connectors along edge 12-1 can be male and female connectors. In FIG. 10 male connector 16-1-1 and female connector 16-1-2 are positioned along edge 12-1. Along neighboring edge 12-2 male connector 16-2-1 and female connector 16-2-2 are positioned in an alternated manner: female connectors in the place of male connectors and vise versa. In this embodiment the connectors of the first connector array form a checkerboard pattern.

As shown in FIG. 10, in the second connector array connectors 26-1-1 and 26-1-2 along edge 22-1, and connectors 26-2-1 and 26-2-2 along edge 22-2 form a checkerboard pattern as well. The location of second function cards 104 is shifted for the clarity of drawing. In fact the female connectors of the second connector array line up with the male connectors of the first connector array and vice versa. Therefore, in this embodiment the first connector array is reciprocal with the second connector array.

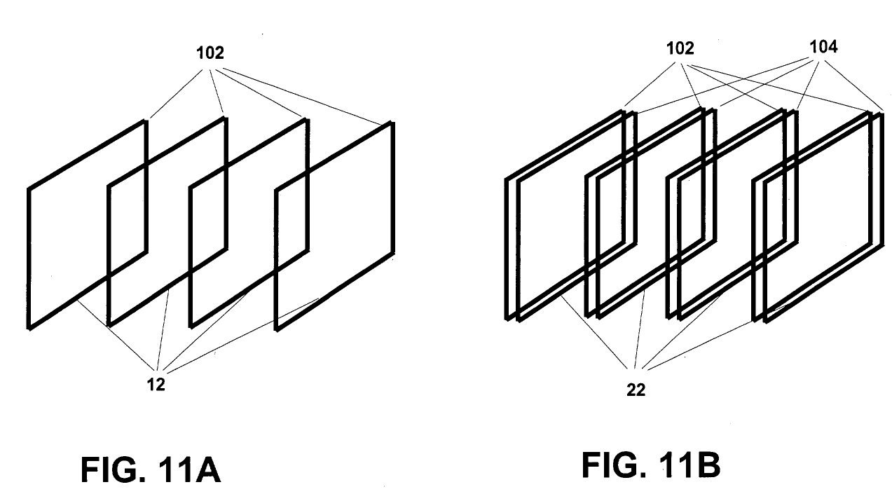

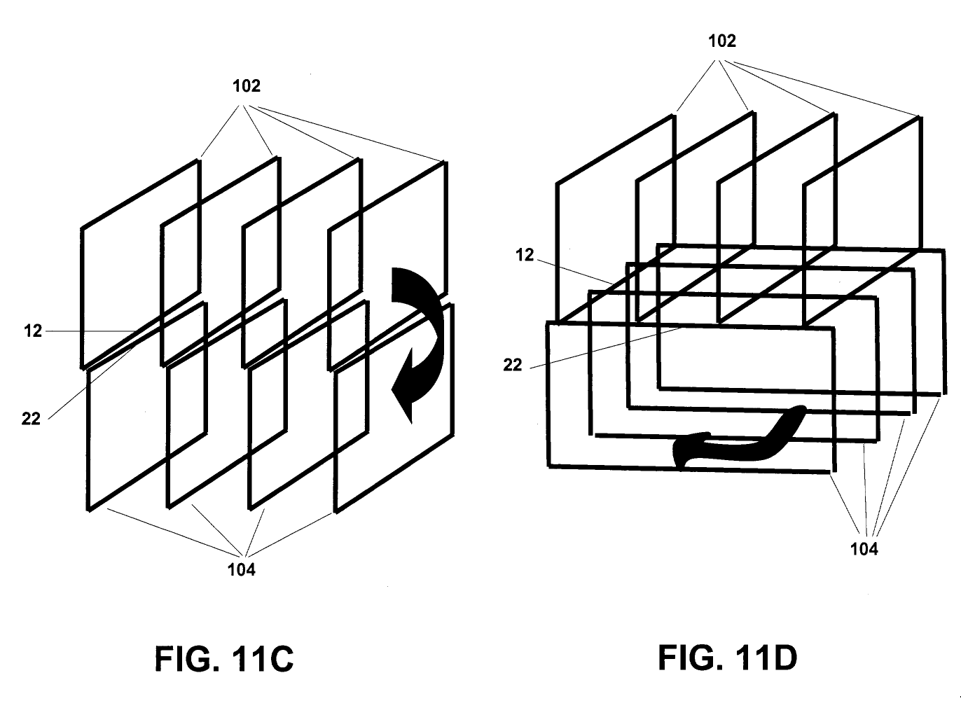

FIGS. 11 A-D illustrates that interconnected system 100 can be formed, for example, by the following steps. In FIG. 11A, first function cards 102 are aligned substantially parallel to each other separated by some preset distance, mid-connect edges 12 defining virtual midplane 11. In FIG. 11B, second function cards 104 are aligned substantially identically with first function cards, mid-connect edges 22 substantially coinciding with mid-connect edges 12.

Interconnected system 100 is then formed by performing geometrical transformations on second function cards 104. Such a geometrical transformation also constitutes a geometrical transformation on the second connector array, located at the mid-connect edges 22 of second function cards 104. In FIG. 11C, a substantially 180 degree reflection is performed on second function cards 104, using mid-connect edges 22 as centers of reflection. In FIG. 11D, a substantially 90 degree rotation is performed on second function cards 104 around an axis, substantially perpendicular to midplane 11, the axis piercing midplane 11 approximately in its center. In FIG. 11C and FIG. 11D only one of mid-connect edges 12 and 22 are labeled each, for clarity.

Many embodiments are related to the one illustrated by FIG. 11. In relation to FIG. 11A, in some embodiments function cards 102 are not evenly spaced. In others, mid-connect edges 12 do not fall into a single plane. The set of connectors along mid-connect edges 12 can be evenly or unevenly spaced; it can also be grouped in various arrangements, for example corresponding to the functions of the circuit elements on the corresponding areas of function cards 102.

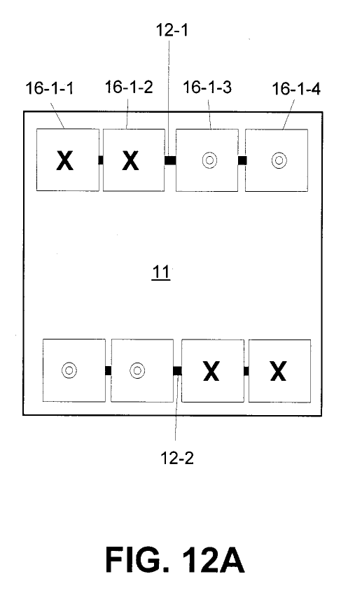

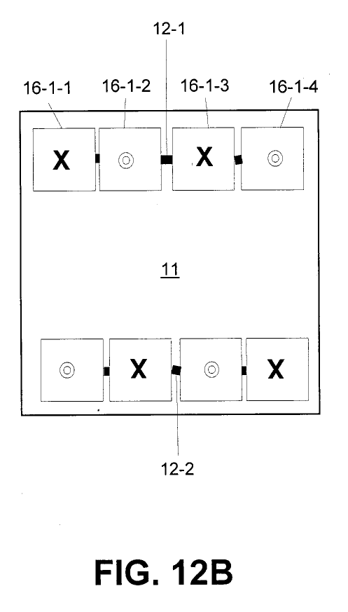

Examples of such groupings of the set of connectors are shown in FIGS. 12A-B. FIG. 12A illustrates that on some function cards the male and female connectors are positioned in groupings along mid-connect edge 12-1. For example, the male connectors are positioned into male groups, the male groups including two male connectors, and the female connectors are grouped into female groups, the female groups including two female connectors. In FIG. 12A, male connectors 16-1-1 and 16-1-2 form a male group and female connectors 16-1-3 and 16-1-4 form a female group. In this case connectors 16-2-1, . . . 16-2-4 on neighboring mid-connect edge 12-2 have the same grouping, but the male and female connector groups interchanged. In several embodiments the female and male connector groups are positioned in some form of an alternating pattern.

FIG. 12B illustrates that the spacing between connectors 16-1-1, . . . 16-1-4 along mid-connect edge 12-1 can be different from the spacing between connectors 16-1-1 and 16-2-1, across mid-connect edges 12-1 and 12-2.

In relation to FIG. 11B, in some embodiments not every function card 102 is paired up with a function card 104.

In relation to FIG. 11C, the reflection can be other than 180 degree.

In relation to FIG. 11D, the rotation can be other than 90 degree. The rotation can also be performed around an axis, which is not centrally located. Also, other geometrical transformations can be performed on function cards as well. For example, additional shifts of function cards 104 can be performed too. The shifts can be performed along any axis in midplane 11.

The connector arrays, in which the connectors and their sets and groups are positioned, are selected so that after a suitable geometrical transformation on the second connector array the first connector array be reciprocal to the second connector array. This reciprocity makes it possible to couple the first and second connector arrays together by electrically coupling the aligned male and female connectors.

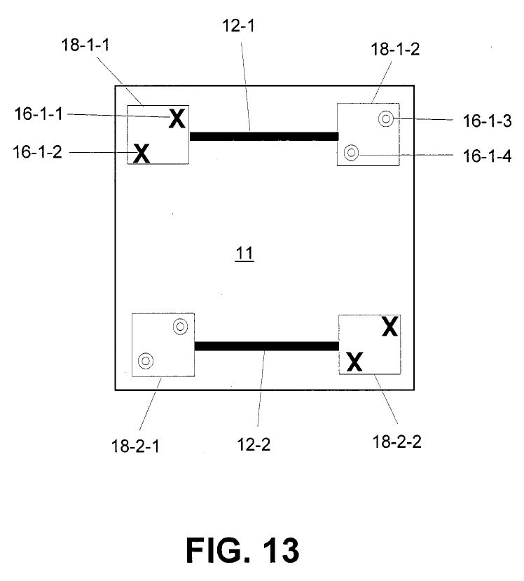

FIG. 13 illustrates embodiments, where male groups include male connectors, which are not positioned along mid-connect edges. For example, male group 18-1-1 can be substantially square shaped and include male connectors 16-1-1 and 16-1-2, positioned diagonally across male group 18-1-1. In some embodiments, male connectors 16-1-1 and 16-1-2 are positioned on opposing sides of function card 104. Neighboring female group 18-1-2 includes female connectors 16-1-3 and 16-1-4, which are positioned diagonally across female group 18-1-2. Along neighboring mid-connect edge 12-2 connectors 16-2-1 . . . 16-2-4 are positioned in an analogous manner, but the positions of the male and female connectors interchanged. Once again, this interchanged alternating arrangement of male and female connectors makes it possible that after a suitable geometrical transformation of the second connector array the first connector array is reciprocal to the second connector array.

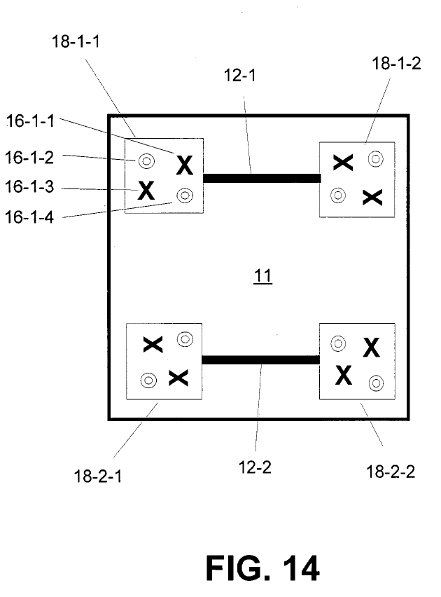

FIG. 14 illustrates a further embodiment. Male and female connectors are organized into connector groups 18-1-1 . . . 18-2-2. In this embodiment connector groups 18-1-1 . . . 18-2-2 contain both male and female connectors. For example, square shaped connector group 18-1-1 includes male connectors 16-1-1 and 16-1-3, positioned along a diagonal of the square, and female connectors 16-1-2 and 16-1-4, positioned along the opposite diagonal of the square. In some embodiments the male connectors along a diagonal are located on opposing sides of the function card. In neighboring connector group 18-1-2 along mid-connect edge 12-1, and in connector group 18-2-1 on neighboring mid-connect edge 12-2, the locations of male and female connectors are interchanged. Therefore, the orientations of the male and female connectors within the connector groups form a checkerboard pattern.

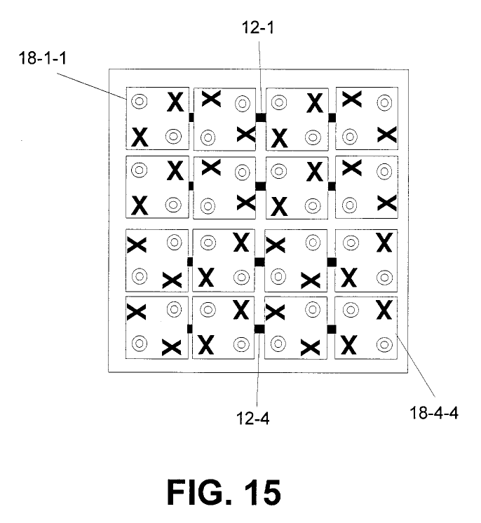

FIG. 15 illustrates an embodiment, where the orientation of the male connector diagonals in the connector groups varies according to a checkerboard pattern.

This interchanged and alternating positioning of male and female connectors makes it possible that after suitable geometrical transformations of the second connector array the first connector array is reciprocal to the second connector array.

As described above, when the first connector array is reciprocal to the second connector array, the two connector arrays can be coupled electronically by coupling the aligned female and male connectors directly, without a back plane or printed circuit board.

While the invention has been described with reference to particular example embodiments, it is intended to cover all modifications and equivalents within the scope of the following claims.

What is claimed is:

1. An interconnected system of function cards, the interconnected system comprising:
a plurality of function cards, the function cards having substantially identical sets of connectors, wherein the plurality of function cards comprises
a group of first function cards with first sets of connectors, wherein the first sets of connectors form a first connector array; and
a group of second function cards with second sets of connectors, wherein the second sets of connectors form a second connector array, wherein
the first connector array is reciprocal to the second connector array.

2. The interconnected system of claim 1, wherein the first connector array being reciprocal to the second connector array comprises
the first connector array being related to the second connector array by a geometric transformation.

3. The interconnected system of claim 2, wherein the geometric transformation comprises at least one of a
a substantially 90 degree rotation, a reflection, and a shift.

4. The interconnected system of claim 1, wherein
the first function cards are substantially parallel to each other; and
the second function cards are substantially parallel to each other.

5. The interconnected system of claim 1, wherein
the first function cards have first mid-connection edges, the first sets of connectors being positioned along the first mid-connection edges; and
the second function cards have second mid-connection edges, the second sets of connectors being positioned along the second mid-connection edges.

6. The interconnected system of claim 5, wherein the sets of connectors comprise male connectors and female connectors.

7. The interconnected system of claim 6, wherein the first connector array being reciprocal to the second connector array comprises
the female connectors of the first connector array being aligned with the male connectors of the second connector array.

8. The interconnected system of claim 6, wherein
the male and female connectors of the first connector array are positioned in a first alternating pattern; and
the male and female connectors of the second connector array are positioned in a second alternating pattern.

9. The interconnected system of claim 8, wherein the alternating patterns comprise
alternating patterns with different periods of repetition along the mid-connection edges of the function cards and perpendicular to the mid-connection edges of the function cards.

10. The interconnected system of claim 8, wherein
the first alternating pattern comprises a first checkerboard of male and female connectors; and
the second alternating pattern comprises a second checkerboard of male and female connectors.

11. The interconnected system of claim 10, wherein the first connector array being reciprocal to the second connector array comprises
the female connectors of the first checkerboard being aligned with the male connectors of the second checkerboard.

12. The interconnected system of claim 11, wherein the first connector array being reciprocal to the second connector array comprises
the first checkerboard being created by a substantially 90 degree rotation of the second checkerboard.

13. The interconnected system of claim 6, wherein the set of connectors of a function card comprise
male connectors, positioned in male groups; and
female connectors, positioned in female groups.

14. The interconnected system of claim 13, wherein
the male groups comprise male squares, the male connectors being positioned pair-wise diagonally within the male squares; and
the female groups comprise female squares, the female connectors being positioned pair-wise diagonally within the female squares.

15. The interconnected system of claim 14, wherein
the diagonals of at least one of the male and female connectors within their corresponding squares are parallel within at least one of the first and second connector arrays.

16. The interconnected system of claim 14, wherein the male groups and the female groups are positioned in an alternating pattern along the mid-connection edge of the function cards.

17. The interconnected system of claim 6, wherein the set of connectors of a function card comprise
connector groups, the connector groups comprising
male and female connectors.

18. The interconnected system of claim 17, wherein a connector group comprises
male-female connector squares, the squares comprising:
two male connectors, positioned along a male diagonal of a square; and
two female connectors, positioned along a female diagonal of the same square, wherein the male diagonal is substantially perpendicular to the female diagonal.

19. The interconnected system of claim 18, wherein the orientations of the male diagonals of the male-female connector squares vary in an alternating pattern.

20. The interconnected system of claim 18, wherein
the orientations of the male-female connector squares of the first connector array vary according to a first checkerboard pattern; and
the orientation of the male-female connector squares of the second connector array vary according to a second checkerboard pattern.

21. The interconnected system of claim 1, wherein the first function cards and the second function cards are coupled without a printed circuit board.
